(19) United States
(12) Patent Application Publication
(10) Pub. No.: US 2021/0057711 A1
(43) Pub. Date: Feb. 25, 2021

(54) TAB, ELECTRODE PLATE, AND BATTERY

(71) Applicant: NINGDE AMPEREX TECHNOLOGY LIMITED, Ningde City (CN)

(72) Inventor: Peilei YANG, Ningde City (CN)

(21) Appl. No.: 16/999,911

(22) Filed: Aug. 21, 2020

(30) Foreign Application Priority Data
Aug. 23, 2019 (CN) 201910785992.6

(51) Int. Cl. H01M 2/26

(52) U.S. Cl. CPC H01M 2/266

(57) ABSTRACT

A tab includes a tab body, where the tab body includes a first end, a second end, and a side connected to the first end and the second end along a length direction. The tab further includes a plurality of protruding portions and/or recessed portions disposed on the side, where the plurality of protruding portions have different maximum heights or the plurality of recessed portions have different maximum depths. During packaging, the tab helps improve packaging reliability.

### CROSS-REFERENCE TO RELATED APPLICATIONS

This application claims priority to Chinese Application No. 201910785992.6 filed on Aug. 23, 2019, the contents of which are incorporated by reference herein.

### TECHNICAL FIELD

This application relates to the battery field, and in particular, to a tab, an electrode plate, and a battery.

### BACKGROUND

As people have higher requirements on high-rate charging/discharging of a battery cell, a thickness of a metal conductive sheet of a tab should also increase. A contact area between a side of the metal conductive sheet and a sealant becomes a potential channel for penetration of a vapor, an electrolyte, or the like, which is one of weaknesses that affect packaging reliability of a soft-package battery cell.

In the related art, the tab is subjected to poor packaging, weak adhesion, or the like, and impacts of such cases on packaging reliability mainly include: (1) in a high-rate charging/discharging process, uneven sealing of the sealant on a side of the tab causes the vapor, electrolyte, or the like to easily penetrate along the side of the metal conductive sheet, leading to a battery cell failure or leakage; and (2) because the adhesion between the metal conductive sheet and the sealant is insufficient, the packaging is poor, and the metal conductive sheet easily falls out.

Importance has been attached to packaging reliability of a soft-package lithium-ion battery. In particular, a soft-package lithium-ion battery applied to an energy storage system has a stricter requirement on long-term reliability of packaging. Therefore, improving packaging reliability of a tab and a packaging bag is of vital importance to safety of a battery.

### SUMMARY

In view of the foregoing problems, a tab that helps to improve packaging reliability, an electrode plate, and a battery need are provided.

An embodiment of this application provides a tab, including a tab body, where the tab body includes a first end, a second end, and a side connected to the first end and the second end along a length direction of the tab, and the tab further includes a plurality of protruding portions and/or a plurality of recessed portions disposed on the side, where the plurality of protruding portions have different maximum heights or the plurality of recessed portions have different maximum depths.

In some embodiments, in the length direction of the tab, the plurality of protruding portions and/or the plurality of recessed portions are disposed at intervals, and the maximum heights of the plurality of protruding portions or the maximum depths of the plurality of recessed portions sequentially increase from the first end to the second end respectively.

In some embodiments, a ratio of a maximum height of a protruding portion near the first end to a maximum height of a protruding portion near the second end is greater than 1:4, or a ratio of a maximum depth of a recessed portion near the first end to a maximum depth of a recessed portion near the second end is greater than 1:4.

In some embodiments, in the length direction of the tab, the plurality of protruding portions and/or the plurality of recessed portions are disposed at intervals, and a maximum height of an outermost protruding portion is greater than a maximum height of a middle protruding portion, or a maximum depth of an outermost recessed portion is greater than a maximum depth of a middle recessed portion.

In some embodiments, a ratio of the maximum height of the outermost protruding portion to the maximum height of the middle protruding portion is greater than 4:1, or a ratio of the maximum depth of the outermost recessed portion to the maximum depth of the middle recessed portion is greater than 4:1.

In some embodiments, a cross-section of each of the protruding portions or the recessed portions is in a shape of a semi-circle, a triangle, a semi-ellipse, a trapezoid, a circular arc, an elliptical arc, or a wedge.

In some embodiments, each of the protruding portions is a wedge object having a cross-section in a shape of a wedge or each of the recessed portions is a wedge groove having a cross-section in a shape of a wedge, a width of the wedge object gradually decreases externally from the side along a maximum height direction of the wedge object or a width of the wedge groove gradually decreases internally from the side along a maximum depth direction of the wedge groove, and the wedge object or the wedge groove includes a first wedge portion and a second wedge portion, where the first wedge portion protrudes externally from the side or is recessed internally from the side, and the second wedge portion is disposed on an end face of the first wedge portion far away from the side to have a step-shaped connection with the first wedge portion.

In some embodiments, the cross-section of the protruding portion or the recessed portion is in a shape of a circular arc or an elliptical arc, a radian of any point on the circular arc or the elliptical arc is θ, where θ is greater than 45 degrees and less than 90 degrees.

An electrode plate includes a current collector, where the electrode plate further includes the foregoing tab, and the first end of the tab connects with the current collector.

A battery includes a battery cell, a sealant layer, and a packaging film for sealing the battery cell, where the battery further includes the foregoing tab, the first end of the tab connects with the battery cell, the second end of the tab passes through the sealant layer and extends out of the packaging film, the sealant layer is adherent to the packaging film and the tab, and the plurality of protruding portions and/or the plurality of recessed portions are disposed in a contact area between the tab and the sealant layer.

According to the tab, electrode plate, and battery in this application, protruding portions of different heights and/or recessed portions of different depths are disposed on the side of the tab body, and when the battery cell to which the tab is applied is packaged, the protruding portions and/or the recessed portions increase a contact area between the tab and the sealant layer, so that an adhesion between the tab and the sealant layer is increased. The protruding portions of different heights or the recessed portions of different depths make cooperation between the tab and the sealant layer firmer, and can prevent a liquid sealed in the packaging film from leaking along the tab, while preventing the tab from falling off, so that the packaging reliability of the battery cell is improved.

### BRIEF DESCRIPTION OF THE DRAWINGS

FIG. 1 is a schematic structural diagram of a tab according to a first embodiment of this application;

FIG. 2 is a partial schematic structural diagram of a tab according to another embodiment of this application;

FIG. 3 is a schematic structural diagram of a tab according to a second embodiment of this application;

FIG. 4 is a schematic structural diagram of a tab according to a third embodiment of this application;

FIG. 5 is a schematic structural diagram of a tab according to a fourth embodiment of this application;

FIG. 6 is a schematic structural diagram of a tab according to a fifth embodiment of this application;

FIG. 7 is a schematic structural diagram of a tab according to a sixth embodiment of this application;

FIG. 8 is a schematic structural diagram of a tab according to a seventh embodiment of this application;

FIG. 9 is a schematic structural diagram of a tab according to an embodiment of this application;

FIG. 10 is a schematic structural diagram of a tab according to another embodiment of this application;

FIG. 11 is a schematic structural diagram of a tab according to still another embodiment of this application;

FIG. 12 is a schematic three-dimensional structural diagram of a tab according to an embodiment of this application;

FIG. 13 is a schematic three-dimensional structural diagram of a tab according to another embodiment of this application;

FIG. 14 is a schematic structural diagram of an electrode plate according to an embodiment of this application; and

FIG. 15 is a schematic structural diagram of a battery according to an embodiment of this application.

### DESCRIPTION OF REFERENCE NUMBERS OF MAIN COMPONENTS

Tab 100

Tab body 10

First end 11

Second end 13

Side 15

Protruding portion 30a

Recessed portion 30b

Length direction X

First wedge portion 31

Second wedge portion 33

Electrode plate 200

Battery 300

Battery cell 301

Sealant layer 302

Packaging film 303

In the following embodiments, this application is further described with reference to the accompanying drawings.

### DETAILED DESCRIPTION

The following clearly describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

Unless otherwise defined, meanings of all technical and scientific terms used in the specification are the same as those generally understood by a person skilled in the art. The terms used in the specification of this application herein are used only to describe specific embodiments, and not intended to limit this application.

The following describes in detail some implementations of this application with reference to the accompanying drawings. Under a condition that no conflict occurs, the following embodiments and features in the embodiments may be mutually combined.

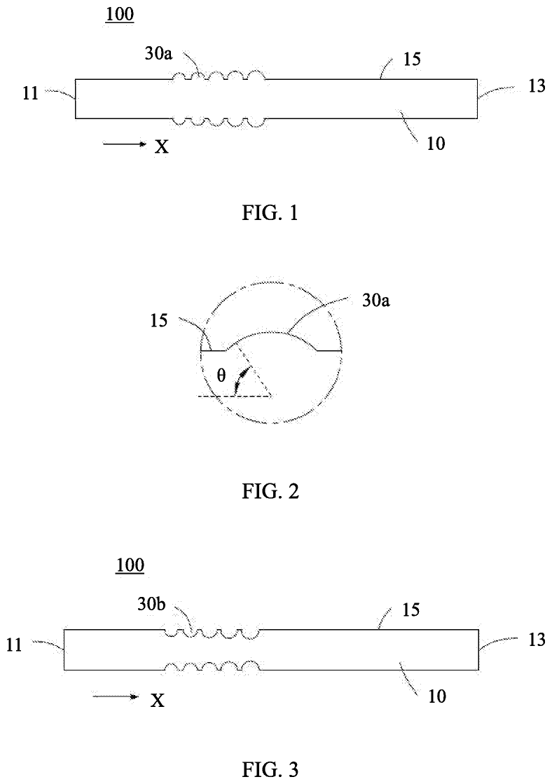

FIG. 1 to FIG. 10 are schematic structural diagrams of a tab according to embodiments of this application, which may be understood as main views of the tab, that is, a plurality of protruding portions 30a and/or recessed portions 30b are disposed on a side 15 of a tab body 10.

Referring to FIG. 1 to FIG. 11, a tab 100 includes a tab body 10. The tab body 10 includes a first end 11, a second end 13, and a side 15 connected to the first end 11 and the second end 13 along a length direction X. The tab 100 further includes a plurality of protruding portions 30a and/or recessed portions 30b disposed on the side 15. The plurality of protruding portions 30a have different maximum heights or the plurality of recessed portions 30b have different maximum depths. Herein, the maximum height of the protruding portion 30a is a distance from a highest point of the protruding portion 30a to the side 15, and the maximum depth of the recessed portion 30b is a distance from a lowest point of the recessed portion 30b to the side 15.

In some embodiments, in the length direction X of the tab 100, the plurality of protruding portions 30a and/or the plurality of recessed portions 30b are disposed at intervals. Height directions of the plurality of protruding portions 30a and depth directions of the plurality of recessed portions 30b are vertical to the length direction X.

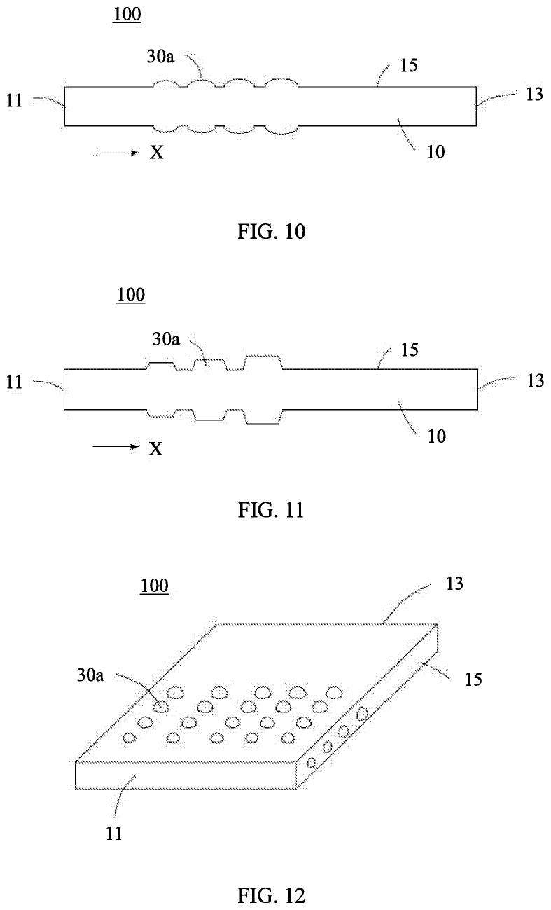

In some embodiments, a cross-section of each of the protruding portions 30a or each of the recessed portions 30b along the length direction X may be in a shape of a semi-circle, a triangle (referring to FIG. 9), a semi-ellipse (referring to FIG. 10), a trapezoid (referring to FIG. 11), a circular arc, an elliptical arc, or a wedge. When the cross-section of the protruding portion 30a or the recessed portion 30b is in a shape of a circular arc or an elliptical arc, an included angle between the length direction X and a line connecting any point on the circular arc or the elliptical arc to a corresponding center of a circle is defined as a radian θ. In some embodiments, θ is greater than 45 degrees and less than 90 degrees (referring to FIG. 2).

In a first embodiment, referring to FIG. 1, the plurality of protruding portions 30a are disposed at intervals in the length direction X of the tab 100, and the maximum heights of the plurality of protruding portions 30a sequentially increase from the first end 11 to the second end 13.

In this embodiment, the cross-section of each of the protruding portions 30a is in a shape of a semi-circle, that is, each of the protruding portions 30a is a hemisphere.

In some embodiments, a ratio of a maximum height of a protruding portion 30a near the first end 11 to a maximum height of a protruding portion 30a near the second end 13 is greater than 1:4.

In a second embodiment, referring to FIG. 3, the plurality of recessed portions 30b are disposed at intervals in the length direction X of the tab 100, and the maximum depths of the plurality of recessed portions 30b sequentially increase from the first end 11 to the second end 13.

In this embodiment, the cross-section of each of the recessed portions 30b is in a shape of a semi-circle.

In some embodiments, a ratio of a maximum depth of a recessed portion 30b near the first end 11 to a maximum depth of a recessed portion 30b near the second end 13 is greater than 1:4.

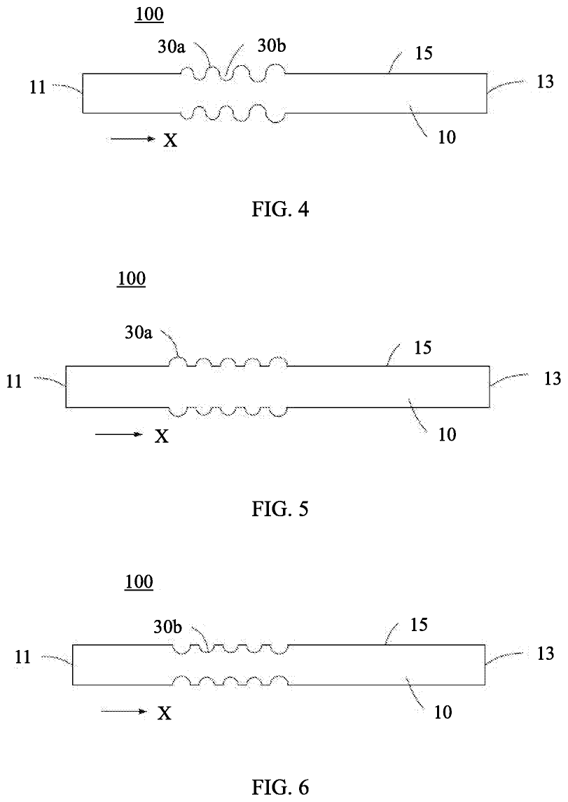

In a third embodiment, referring to FIG. 4, the tab 100 includes a plurality of protruding portions 30a and a plurality of recessed portions 30b, where the protruding portions 30a and the recessed portions 30b are alternately disposed along the length direction X.

In some embodiments, the maximum heights of the plurality of protruding portions 30a sequentially increase from the first end 11 to the second end 13, or the maximum depths of the plurality of recessed portions 30b sequentially increase from the first end 11 to the second end 13.

In a fourth embodiment, referring to FIG. 5, in the length direction X of the tab 100, the plurality of protruding portions 30a are disposed at intervals, and a maximum height of an outermost protruding portion 30a is greater than a maximum height of a middle protruding portion 30a.

In some embodiments, a ratio of the maximum height of the outermost protruding portion 30a to the maximum height of the middle protruding portion 30a is greater than 4:1.

In a fifth embodiment, referring to FIG. 6, in the length direction X of the tab 100, the plurality of recessed portions 30b are disposed at intervals, and a maximum depth of an outermost recessed portion 30b is greater than a maximum depth of a middle recessed portion 30b.

In some embodiments, a ratio of the maximum depth of the outermost recessed portion 30b to the maximum depth of the middle recessed portion 30b is greater than 4:1.

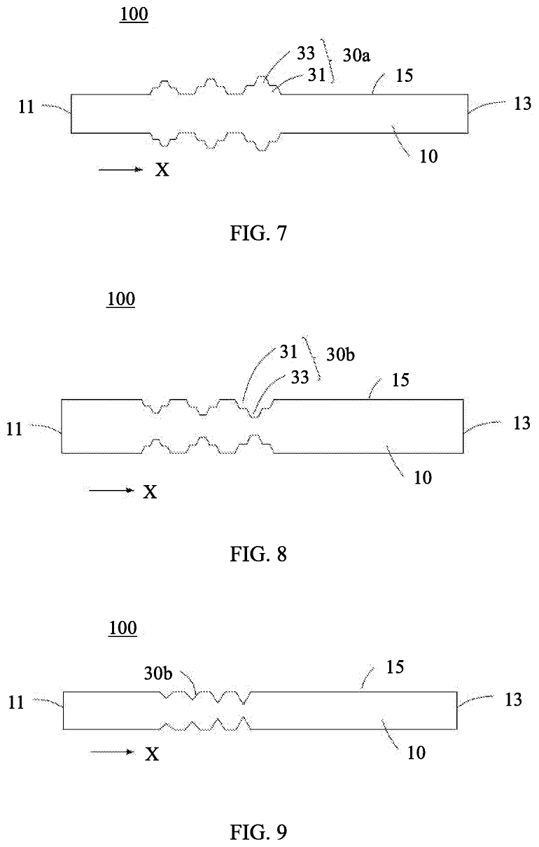

In a sixth embodiment, referring to FIG. 7, a difference from the first embodiment lies in that each of the protruding portions 30a is a wedge object having a cross-section in a shape of a wedge, where a width of the wedge object gradually decreases externally from the side 15 along a maximum height direction of the wedge object.

In some embodiments, in this embodiment, the wedge object includes a first wedge portion 31 and a second wedge portion 33. The first wedge portion 31 protrudes externally from the side 15. The second wedge portion 33 is disposed on an end face of the first wedge portion 31 far away from the side 15, and the second wedge portion 33 has a step-shaped connection with the first wedge portion 31.

In some embodiments, the tab 100 may include one wedge object having a cross-section in a shape of a wedge as described above.

In a seventh embodiment, referring to FIG. 8, a difference from the second embodiment lies in that each of the recessed portions 30b is a wedge groove having a cross-section in a shape of a wedge, where a width of the wedge groove gradually decreases internally from the side 15 along a maximum depth direction of the wedge groove.

In this embodiment, the wedge groove includes a first wedge portion 31 and a second wedge portion 33. The first wedge portion 31 is recessed internally from the side 15. The second wedge portion 33 is disposed on an end face of the first wedge portion 31 far away from the side 15, and the second wedge portion 33 has a step-shaped connection with the first wedge portion 31.

In some embodiments, the tab 100 may include one wedge groove having a cross-section in a shape of a wedge as described above.

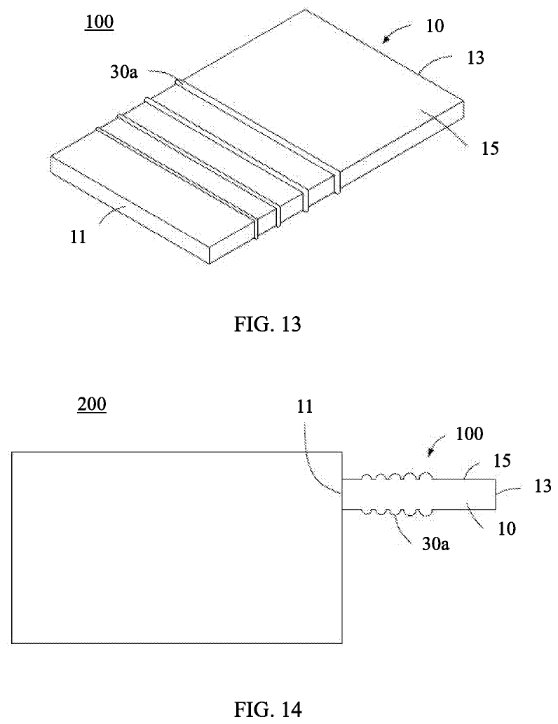

In some embodiments, the protruding portions 30a or the recessed portions 30b may be distributed on the side 15 like dots, as shown in FIG. 12. In some embodiments, alternatively, the protruding portions 30a or the recessed portions 30b may be distributed on the side 15 like windings, as shown in FIG. 13.

Referring to FIG. 14, the tab 100 in each of the foregoing embodiments is applied to an electrode plate 200. The electrode plate 200 further includes a current collector (not shown in the figure). The first end 11 of the tab 100 connects with the current collector.

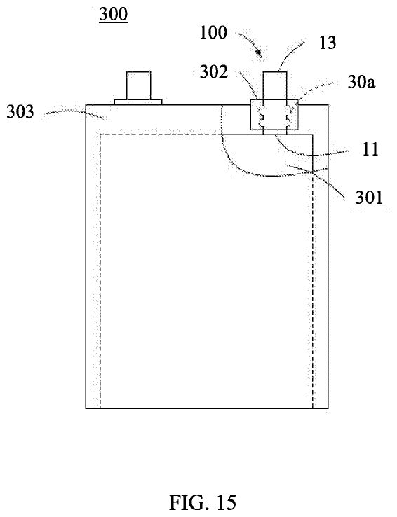

Referring to FIG. 15, the tab 100 in each of the foregoing embodiments is applied to a battery 300. The battery 300 further includes a battery cell 301, a sealant layer 302, and a packaging film 303 for sealing the battery cell 301. The first end 11 of the tab 100 connects with the battery cell 301. The second end 13 of the tab 100 passes through the sealant layer 302 and extends out of the packaging film 303. The sealant layer 302 is adherent to the packaging film 303 and the tab 100, and the plurality of protruding portions 30a or the plurality of recessed portions 30b are disposed in a contact area between the tab 100 and the sealant layer 302.

In some embodiments, the maximum height of the protruding portion 30a or the maximum depth of the recessed portion 30b is less than one half of a thickness of the sealant layer 302.

The battery 300 may further include an electrolyte (not shown in the figure). The electrolyte is sealed in the packaging film 303.

According to the tab 100 in embodiments of this application, protruding portions 30a of different maximum heights and/or recessed portions 30b of different maximum depths are disposed on the side 15 of the tab body 10, and when the battery cell to which the tab 100 is applied is packaged, the protruding portions 30a and/or the recessed portions 30b increase a contact area between the tab 100 and the sealant layer 302, so that an adhesion between the tab 100 and the sealant layer 302 is increased. The protruding portions 30a of different maximum heights or the recessed portions 30b of different maximum depths make cooperation between the tab 100 and the sealant layer 302 firmer, and can prevent a liquid sealed in the packaging film 303 from leaking along the tab 100 and prevent penetration of an external vapor, while preventing the tab 100 from falling off, so that the reliability of the battery cell is improved. In addition, the protruding portions 30a of different maximum heights or the recessed portions 30b of different maximum depths can further prolong a path in which the vapor, electrolyte, or the like penetrates along the side of the tab. This can further improve the packaging reliability of the battery cell.

In addition, the maximum heights of the plurality of protruding portions 30a and/or the maximum depths of the plurality of recessed portions 30b sequentially increase from the first end 11 to the second end 13, the maximum height of the outermost protruding portion 30a is greater than the maximum height of the middle protruding portion 30a, the maximum depth of the outermost recessed portion 30b is greater than the maximum depth of the middle recessed portion 30b, the wedge object or the wedge groove is step-shaped, θ is greater than 45 degrees and less than 90 degrees, and so on. All the foregoing can further improve the sealing reliability of the tab 100 and the sealant layer 302, and therefore can further improve the packaging reliability of the battery cell.

In addition, a person of ordinary skill in the art may make various other corresponding changes and variations based on the technical idea of this application, but all these changes and variations shall fall within the protection scope of the claims of this application.

What is claimed is:

1. A tab, comprising:
a tab body, wherein the tab body comprises a first end, a second end, and a side connected to the first end and the second end along a length direction of the tab;
a plurality of protruding portions and/or a plurality of recessed portions disposed on the side, wherein the plurality of protruding portions have different maximum heights or the plurality of recessed portions have different maximum depths.

2. The tab according to claim 1, wherein in the length direction of the tab, the plurality of protruding portions and/or the plurality of recessed portions are disposed at intervals, and the maximum heights of the plurality of protruding portions or the maximum depths of the plurality of recessed portions sequentially increase from the first end to the second end respectively.

3. The tab according to claim 2, wherein a ratio of a maximum height of a protruding portion near the first end to a maximum height of a protruding portion near the second end is greater than 1:4, or a ratio of a maximum depth of a recessed portion near the first end to a maximum depth of a recessed portion near the second end is greater than 1:4.

4. The tab according to claim 1, wherein in the length direction of the tab, the plurality of protruding portions and/or the plurality of recessed portions are disposed at intervals, and a maximum height of an outermost protruding portion is greater than a maximum height of a middle protruding portion, or a maximum depth of an outermost recessed portion is greater than a maximum depth of a middle recessed portion.

5. The tab according to claim 4, wherein a ratio of the maximum height of the outermost protruding portion to the maximum height of the middle protruding portion is greater than 4:1, or a ratio of the maximum depth of the outermost recessed portion to the maximum depth of the middle recessed portion is greater than 4:1.

6. The tab according to claim 1, wherein a cross-section of each of the protruding portions or the recessed portions is in a shape of a semi-circle, a triangle, a semi-ellipse, a trapezoid, a circular arc, an elliptical arc, or a wedge.

7. The tab according to claim 6, wherein each of the protruding portions is a wedge object having a cross-section in a shape of a wedge or each of the recessed portions is a wedge groove having a cross-section in a shape of a wedge; a width of the wedge object gradually decreases externally from the side along a maximum height direction of the wedge object or a width of the wedge groove gradually decreases internally from the side along a maximum depth direction of the wedge groove, and the wedge object or the wedge groove comprises a first wedge portion and a second wedge portion, wherein the first wedge portion protrudes externally from the side or is recessed internally from the side, and the second wedge portion is disposed on an end face of the first wedge portion far away from the side to have a step-shaped connection with the first wedge portion.

8. The tab according to claim 6, wherein the cross-section of the protruding portion or the recessed portion is in a shape of a circular arc or an elliptical arc, a radian of any point on the circular arc or the elliptical arc is θ, wherein θis greater than 45 degrees and less than 90 degrees.

9. An electrode plate, comprising:
a current collector; and
a tab comprising a tab body;
wherein, the tab body comprises a first end, a second end, and a side connected to the first end and the second end along a length direction of the tab;
the first end of the tab is connected to the current collector;
the tab further comprises a plurality of protruding portions and/or a plurality of recessed portions disposed on the side, wherein the plurality of protruding portions have different maximum heights or the plurality of recessed portions have different maximum depths.

10. The electrode plate according to claim 9, wherein in the length direction of the tab, the plurality of protruding portions and/or the plurality of recessed portions are disposed at intervals, and the maximum heights of the plurality of protruding portions or the maximum depths of the plurality of recessed portions sequentially increase from the first end to the second end respectively.

11. The electrode plate according to claim 10, wherein a ratio of a maximum height of a protruding portion near the first end to a maximum height of a protruding portion near the second end is greater than 1:4, or a ratio of a maximum depth of a recessed portion near the first end to a maximum depth of a recessed portion near the second end is greater than 1:4.

12. The electrode plate according to claim 9, wherein in the length direction of the tab, the plurality of protruding portions and/or the plurality of recessed portions are disposed at intervals, and a maximum height of an outermost protruding portion is greater than a maximum height of a middle protruding portion, or a maximum depth of an outermost recessed portion is greater than a maximum depth of a middle recessed portion.

13. The electrode plate according to claim 12, wherein a ratio of the maximum height of the outermost protruding portion to the maximum height of the middle protruding portion is greater than 4:1, or a ratio of the maximum depth of the outermost recessed portion to the maximum depth of the middle recessed portion is greater than 4:1.

14. The electrode plate according to claim 9, wherein a cross-section of each of the protruding portions or the recessed portions is in a shape of a semi-circle, a triangle, a semi-ellipse, a trapezoid, a circular arc, an elliptical arc, or a wedge.

15. The electrode plate according to claim 14, wherein each of the protruding portions is a wedge object having a cross-section in a shape of a wedge or each of the recessed portions is a wedge groove having a cross-section in a shape of a wedge, the wedge object gradually decreases externally from the side along a maximum height direction of the wedge object or a width of the wedge groove gradually decreases internally from the side along a maximum depth direction of the wedge groove, and the wedge object or the wedge groove comprises a first wedge portion and a second wedge portion, wherein the first wedge portion protrudes externally from the side or is recessed internally from the side, and the second wedge portion is disposed on an end face of the first wedge portion far away from the side to have a step-shaped connection with the first wedge portion.

16. A battery, comprising:
a battery cell;
a sealant layer;
a packaging film for sealing the battery cell; and
a tab;
wherein, the tab comprises a tab body, the tab body comprises a first end, a second end, and a side connected to the first end and the second end along a length direction of the tab;
the tab further comprises a plurality of protruding portions and/or a plurality of recessed portions disposed on the side, wherein the plurality of protruding portions have different maximum heights or the plurality of recessed portions have different maximum depths;
wherein the first end of the tab is connected with the battery cell, the second end of the tab passes through the sealant layer and extends out of the packaging film, the sealant layer is adherent to the packaging film and the tab, and the plurality of protruding portions and/or the plurality of recessed portions are disposed in a contact area between the tab and the sealant layer.

17. The battery according to claim 16, wherein in the length direction of the tab, the plurality of protruding portions and/or the plurality of recessed portions are disposed at intervals, and the maximum heights of the plurality of protruding portions or the maximum depths of the plurality of recessed portions sequentially increase from the first end to the second end respectively.

18. The battery according to claim 17, wherein a ratio of a maximum height of a protruding portion near the first end to a maximum height of a protruding portion near the second end is greater than 1:4, or a ratio of a maximum depth of a recessed portion near the first end to a maximum depth of a recessed portion near the second end is greater than 1:4.

19. The battery according to claim 16, wherein in the length direction of the tab, the plurality of protruding portions and/or the plurality of recessed portions are disposed at intervals, and a maximum height of an outermost protruding portion is greater than a maximum height of a middle protruding portion, or a maximum depth of an outermost recessed portion is greater than a maximum depth of a middle recessed portion.

20. The battery according to claim 19, wherein a ratio of the maximum height of the outermost protruding portion to the maximum height of the middle protruding portion is greater than 4:1, or a ratio of the maximum depth of the outermost recessed portion to the maximum depth of the middle recessed portion is greater than 4:1.
